(19) United States
(12) Patent Application Publication
(10) Pub. No.: US 2007/0217490 A1
(43) Pub. Date: Sep. 20, 2007

(54) Modem

(75) Inventors: Trevor Martin Blake, Chelmsford (GB); Neil Bourhill, Blackpool (GB); Stavros Iezekiel, Leeds (GB)

Correspondence Address: KENYON & KENYON LLP, ONE BROADWAY, NEW YORK, NY, 10004, US

(73) Assignee: BAE Systems PLC, London (GB)

(21) Appl. No.: 11/547,794

(22) PCT Filed: Mar. 15, 2006
(86) PCT No.: PCT/GB06/00949

§ 371 Date: Oct. 4, 2006

(30) Foreign Application Priority Data
Mar. 15, 2005 (GB) 0505225.3
Mar. 15, 2005 (EP) 05102046.9

(51) Int. Cl. H04L 5/16; H04K 1/10

(52) U.S. Cl. 375/222; 375/260

(57) ABSTRACT

An apparatus and method for processing a high data rate signal are disclosed. The apparatus includes a plurality of data processing units and a switching arrangement to repeatedly switch a received high first data rate signal between inputs of the plurality of data processing units on a time division basis. Each of the data processing units is operable to process the first signal at a second data rate less than said high first data rate to form respective second signals, and the apparatus further includes a combining arrangement operable to switch between outputs of the plurality of data processing units to form a processed high data rate signal from a combination of said respective second signals. A receiver apparatus is operable to cooperate with the apparatus to receive a processed signal and to undo each of the processing steps performed by the apparatus to convert the processed signal into an original high first data rate signal.

The present invention relates to apparatus and methods for processing high data rate signals, in particular, but not exclusively, for processing radio frequency signals of greater than 54 MBits/s.

Data signals have been transmitted from one place to another by various means such as twisted pair wires, optical fibre and increasingly commonly by wireless transmission. As technology has advanced the amount of data that needs to be transmitted between apparatus has increased significantly, and the data rates have likewise increased. As the data rates of the signals have increased so the characteristics of the signals have changed from being relatively narrow band to being wide band in nature. For example, the Institute of Electrical and Electronic Engineers standards for digital television broadcast systems and wireless local area networks such as IEEE 802.11a, IEEE 802.11b, IEEE 802.11g [1] operate at a data rate of 54 Mbit/s. The wideband nature of the signals, sometimes called broadband signals, results in a sensitivity to the environment in which they are transmitted, generally referred to as a communications channel, and they frequently undergo multiple reflections having different delays and strengths due to the frequency sensitive nature of the communications channel. This can be a problem even over short distances, typically 10 to 100 metres.

The problems with frequency selective communications channels have been addressed by the use of coding and modulation techniques of which coded orthogonal frequency division multiplexing (COFDM) is one example. In COFDM a wideband signal is divided into a number of narrow-band channels. Each channel operates at a slower rate than the wide band signal, but taken together have an effective data rate equivalent to that of the wideband signal by acting in parallel. Since each channel is narrow-band the signals in each channel do not undergo frequency dependent effects than would arise for a wideband channel. Furthermore, proximal parts of the original wide band signal are distributed over different narrow-band channels (so-called interleaving) which means that even if a particular channel experiences degradation due to a multipath delay or other significant interference, any degradation in the signal may be compensated for by the data in the other channels as a result of applying forward error correction (FEC), and the compromised data can be recovered using the unaffected proximal data on the other channels.

COFDM incorporates forward error correction (FEC), which is a coding system designed to allow for the identification and correction of errors in data following transmission. The terms COFDM and OFDM (orthogonal frequency division multiplexing) are generally used interchangeably since in practice it is unlikely that an OFDM signal would be transmitted without FEC.

Forming COFDM communication signals is data processing intensive. As the data rate of signals increases so does the intensity and complexity of the data processing required for forming a COFDM signal. Increasing the data rate of signals far beyond that for wireless LAN systems operating in accordance with the IEEE 802.11a or IEEE 802.11b standards encounters the limitations in processing speed of currently available data processing apparatus. These processing speed limitations restrict the upper data rate at which information may be transmitted. This has meant that real-time transmission of high data rate signals, for example video signals such as digital camera signals with raw data rates in excess of 270 Mbits/s, has so far proved impossible to achieve using COFDM and other processing intensive encoding techniques.

In a known arrangement, described for example in a Japanese patent application with publication reference JP 2002 290368, a COFDM transmitter/receiver system makes use of a parallel processing technique in order to increase the bandwidth of the system. In that arrangement, an input data stream is split, according to a number of frequency bands, into respective parallel data streams each of which is processed separately by a different processing chain. The processed outputs of the processing chains are recombined using multiple digital-to-analogue (D-A) converters and multiple IQ upconverters. However, in such arrangements, creation of multiple frequency-dependent data streams results, aside from the increased cost of implementation, in risks arising from instability of the multiple oscillators and the resulting frequency mismatches between streams. Moreover, COFDM is sensitive to IQ mismatch between the I and Q channels whereby any mismatch in amplitude and phase response of these components can incur a bit—error—rate penalty. The use of multiple IQ modulators for the parallel streams raises the risk of such a incurring a bit—error—rate penalty.

Viewed from a first aspect the present invention provides an apparatus for processing a high data rate signal, comprising:
a plurality of data processing units; and
switching means operable to receive a first signal at a high first data rate and to switch said first signal between inputs of said plurality of data processing units at regular time intervals;
wherein each of said plurality of data processing units is operable to process said first signal at a second data rate less than said high first data rate to form respective second signals; and
wherein said apparatus further comprises combining means operable to switch between outputs of said plurality of data processing units to form a processed high data rate signal from a combination of said respective second signals.

Viewed from a second aspect the present invention provides a receiver, operable to cooperate with a transmitter comprising apparatus according to the first aspect of the present invention, to convert a high data rate signal output by said transmitter following processing by said transmitter of a first high data rate signal, the receiver comprising:
a plurality of data processing units;
demultiplexing means operable to receive a high data rate signal output by said transmitter, and to demultiplex the received signal for input to said plurality of data processing units;
wherein each of said plurality of data processing units is operable to process said received high data rate signal to form signals which, when combined, correspond to said high first data rate signal.

From a third aspect, the present invention resides in a method for processing a high data rate signal, comprising:
receiving a first signal at high first data rate;
dividing said first signal into respective parts based upon regular time intervals;
processing respective parts of said first signal at a second data rate less than said high first data rate to form respective second signals; and
combining said respective second signals to form a processed high data rate signal.

Embodiments of the invention in accordance with the first and second aspects allow for the use of processing modules which operate at lower processing speeds than the data rate of the signal to be processed. Advantageously, this means that cheaper modules operating at a lower processing rate may be used to process data which if processed by a single module would require an expensive module capable of processing at a high data rate. Optionally, signals having data rates exceeding the processing power and speed of existing technology may be processed by the use of more than one processing module to process the high data rate signal.

Preferably, the switching means are operable to process a streaming first signal into blocks of data and to switch blocks of the first signal cyclically between the inputs of the plurality of data processing units. It is possible to leave block processing until just prior to the switching in order to provide streaming data processing for as long as possible. This reduces the processing overhead and improves data throughput.

For an embodiment having just first and second data processing units the apparatus is operative to alternately switch said blocks of data between said first and second data processing unit input.

Typically, each of said plurality of data processing units includes first and second modules, said first module being operable at a third data rate and said second module being operable to receive a signal output from said first module and to process said received signal at a fourth data rate greater than said third data rate for inserting data points into said received signal to form a third signal. For example, the second module may be operable to insert a guard interval into said second signal which advantageously improves error correction whilst at the same time maintaining the high data rate for the processed signal.

Optionally, the processed high data rate signal is an orthogonal frequency division multiplexed or coded orthogonal frequency division multiplexed signal and each of the plurality of data processing units comprises a virtual sub-carrier adder and an inverse fast Fourier transform (IFFT) module, the second module being operative to insert one or more virtual sub-carriers.

In one example, each of said first and second sub-modules comprises a first stage for receiving said second signal at said second data rate, and a second stage for receiving said second signal at said third data rate and outputting said third signal, which advantageously provides for a different clock signal to be applied to respective first and second stages.

Suitably, there is an intermediate data storage stage between the first and second stages switchable between them to isolate them one from another.

Throughout the present patent specification, where any of the words comprise, comprises, comprised or comprising are used, they are intended to be interpreted in their generally accepted non-limiting sense to mean include, includes, included or including but not limited to, respectively.

Specific embodiments of the invention will now be described, by way of example only, and with reference to the following drawings in which:

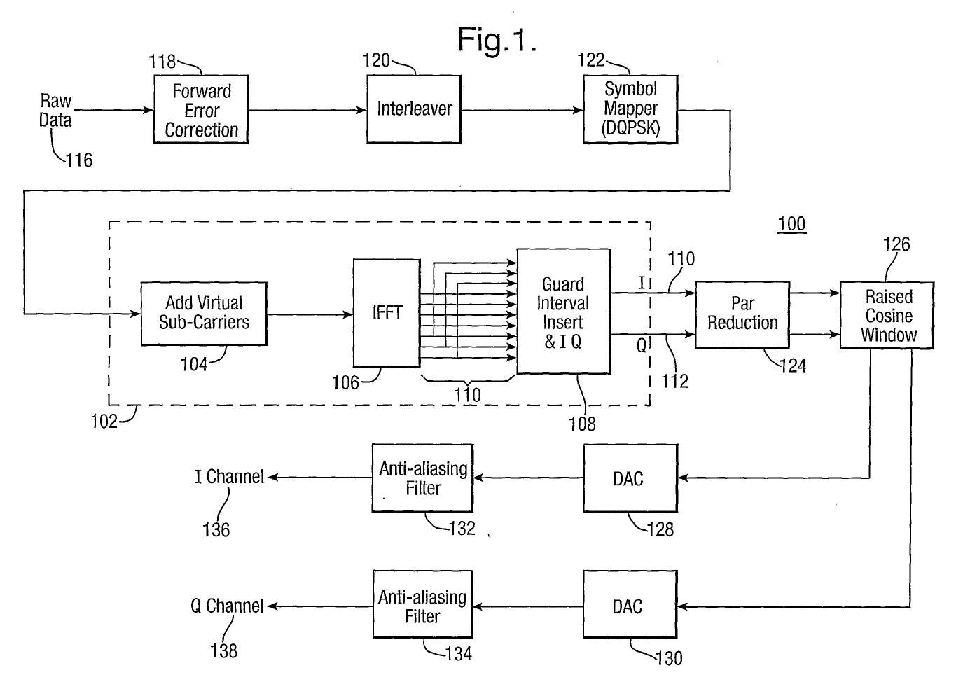

FIG. 1 is a block circuit diagram of a COFDM transmitter modem in accordance with a first embodiment of the present invention;

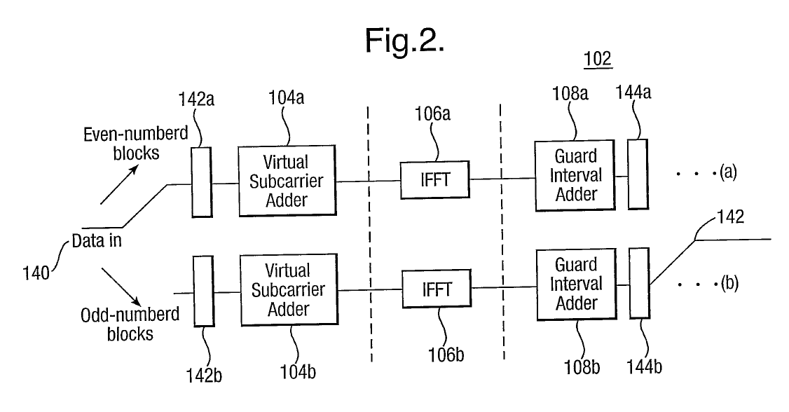

FIG. 2 is a block circuit diagram of a preferred OFDM multiplexed processor unit for a transmitter modem architecture in accordance with the first embodiment of the present invention;

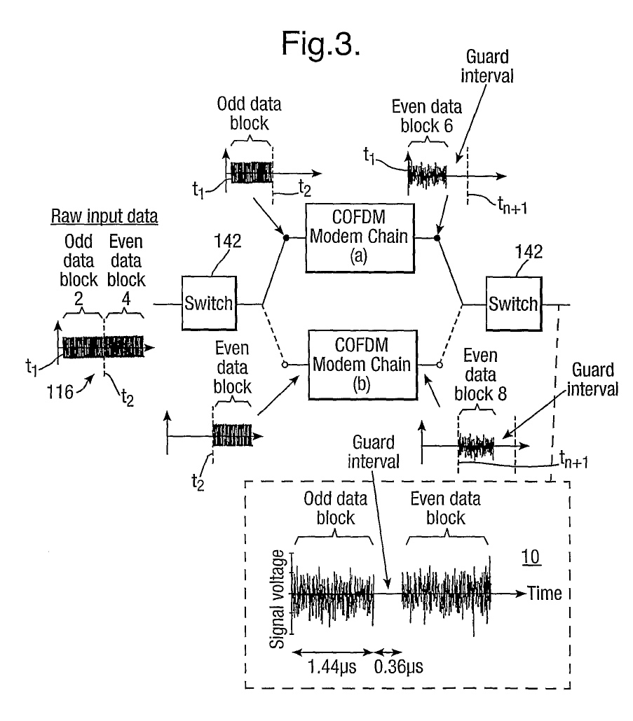

FIG. 3 illustrates the timing of respective odd and even data blocks at the input and output of the COFDM modem processing chain;

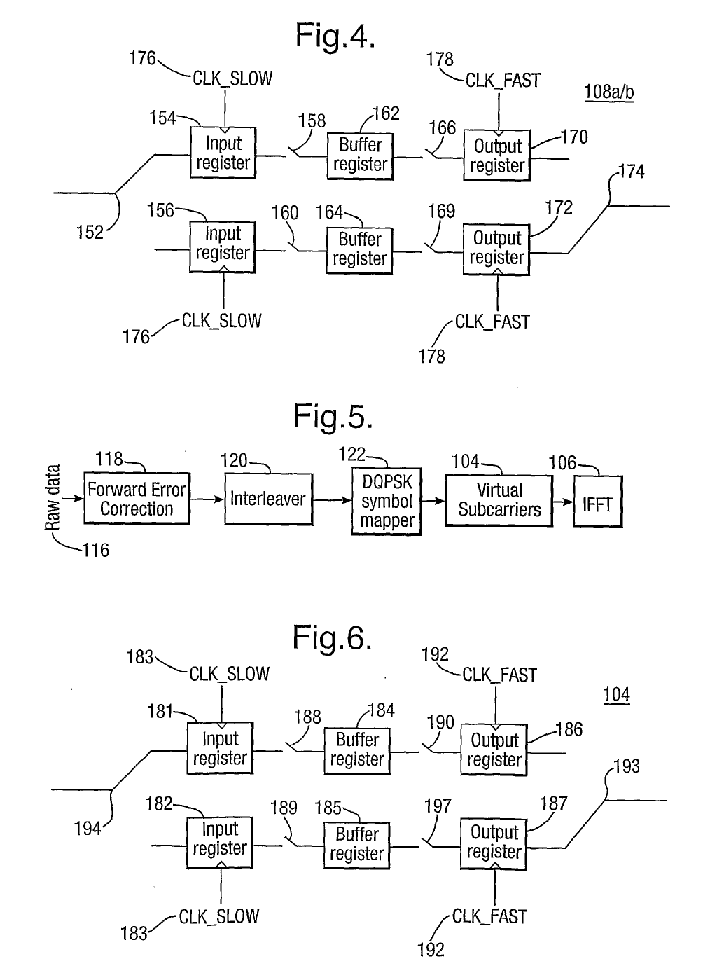

FIG. 4 is a block circuit diagram of a multiplexed guard interval adder for a modem as illustrated in FIG. 2;

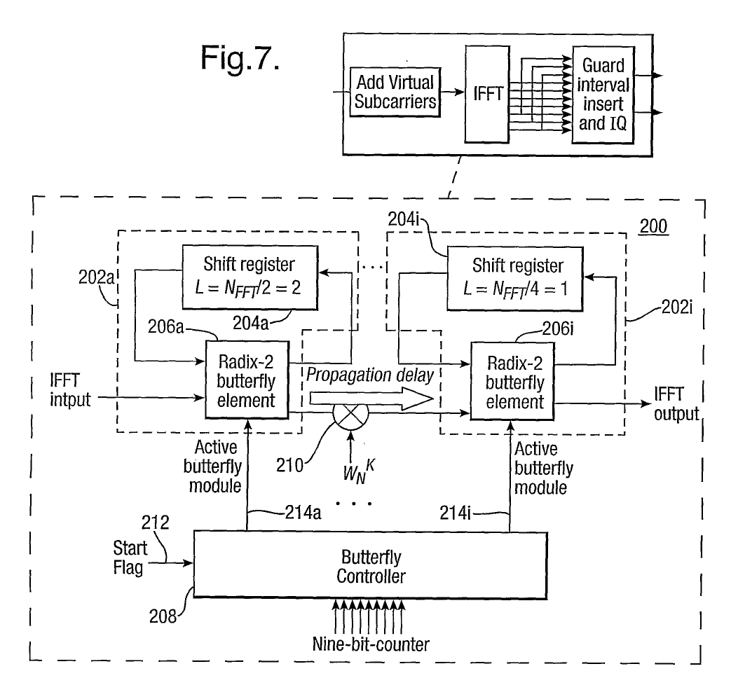

FIG. 5 is a block circuit diagram of the pipeline processing chain for streaming data for the modem illustrated in FIG. 2;

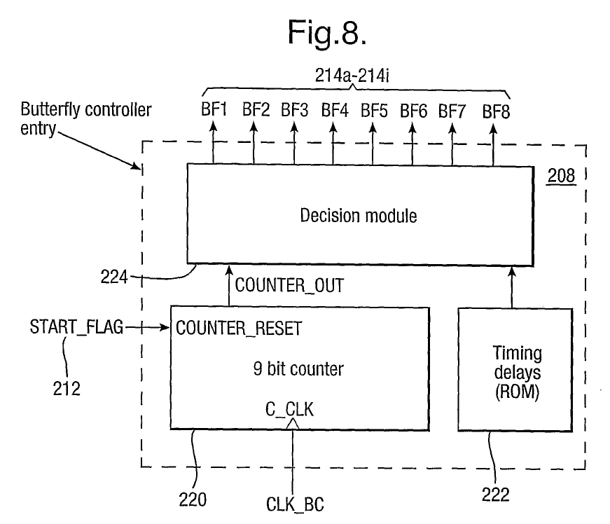

FIG. 6 is a block circuit diagram of a virtual sub-carrier adder for a modem as illustrated in FIG. 2;

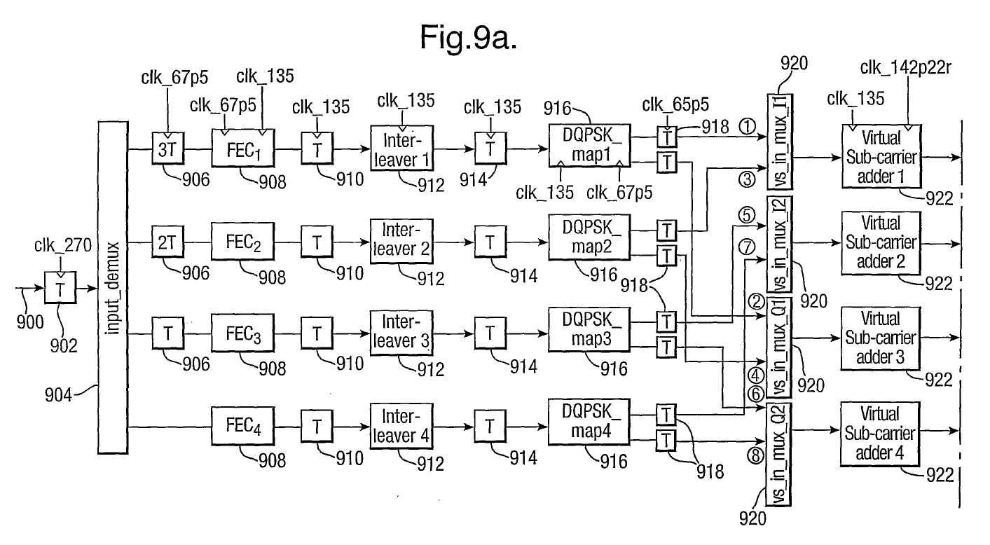

FIG. 7 is a block circuit diagram of the butterfly module for the IFFT unit of the modem illustrated in FIG. 2;

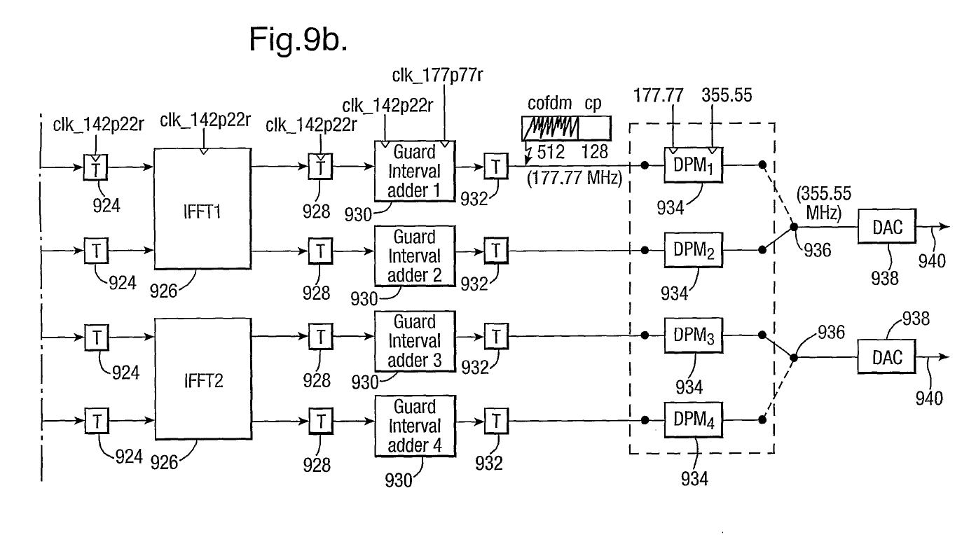

FIG. 8 is a block circuit diagram of the butterfly controller for the butterfly module illustrated in FIG. 7;

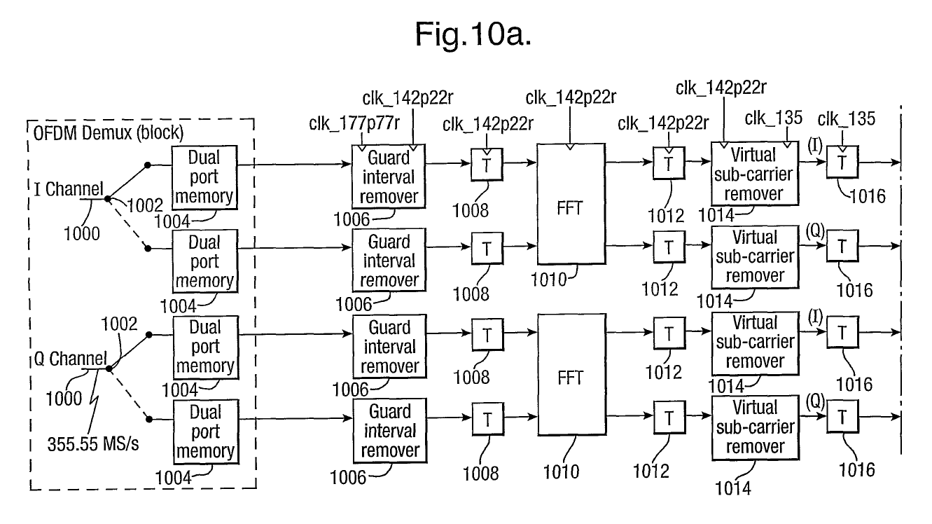

FIG. 9 is a block diagram showing the architecture of a preferred COFDM transmitter modem according to a second embodiment of the present invention; and

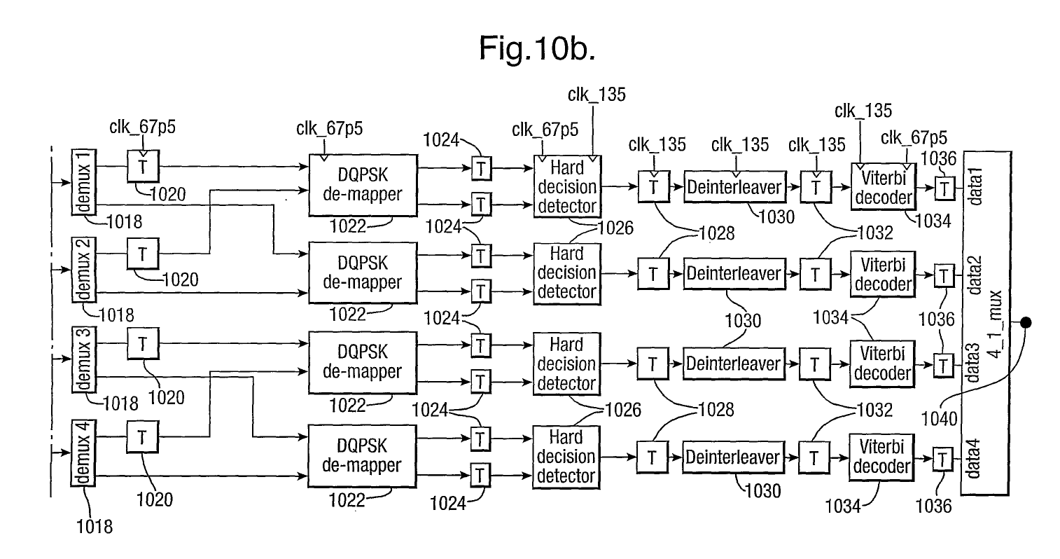

FIG. 10 is an engineering block diagram showing the architecture of a preferred COFDM receiver modem according to a third embodiment of the present invention.

It is commonplace, and indeed even the norm, for raw data to be encoded in some manner in order to reduce the amount of data required to convey information (compression), for example the JPEG (Joint Photographic Expert Group) and MPEG (Moving Pictures Expert Group) coding standards which aim to reduce the amount of data required to represent a still image or video. Such reduction in data reduces storage requirements and also bandwidth requirements for the communication of such data signals. Another example of data encoding is speech coding typically used in cellular telephony. Additionally, signals which are to be communicated over a communications channel such as an optical fibre or a wireless communications channel, even over a short distance such as 10 to 100 metres, are generally modulated onto a carrier signal or signals and also generally undergo various types of coding for error correction and reduction.

Coding and modulation techniques require substantial processing of the data, which introduces a significant processing overhead for the more complex techniques, or where many techniques are applied one after the other, for example speech coding, error coding and modulation onto a carrier signal such as may be the case for cellular telephony.

One example of a coding technique is OFDM. OFDM dates back to the 1960s when Chang published a paper on the transmission of orthogonal multi-channel signals through band limited channels [2]. Shortly after, Saltzburg highlighted the importance of maintaining orthogonality in such systems [3]. In addition, Weinstein and Ebert [4] were the first to use discrete Fourier transforms to generate orthogonal sub-channels. The use of guard intervals was first proposed by Peled and Ruliz in 1980 [5].

The OFDM modulation scheme and associated modems has been in use in a number of existing communications protocols such as for digital television broadcast systems (DVD), digital audio broadcast (DAB), radio and local area networks (W-LAN) systems, for example those operating in accordance with the IEEE standards IEEE 802.11a, IEEE 802.11b and IEEE 802.11g [1]. The particular format for the OFDM modulation scheme used in these systems is defined in the relevant standard.

A number of OFDM-modem designs are commercially available to meet the aforementioned 802.11 standards, or are supplied by companies such as Cisco Systems, Inc. and Atheros, Inc. Another company, Wi-LAN, Inc. has developed a so-called “wideband” OFDM (W-OFDM) technology disclosed in United States patent U.S. Pat. No. 5,282,222, and which is said to relate to the 802.11 standards. However, the data rate of these systems is limited to around 50 Mbit/s, for example Wi-LAN, Inc. operates at the maximum of 54 Mbit/s.

The following examples of embodiments of the present invention are illustrated using COFDM. In a COFDM system a data signal undergoes some form of encoding suitable for the type of transmission that will take place, for example wireless, RF optical fibre or wire line. The encoded signal then undergoes OFDM.

Generally speaking, in OFDM an input signal is split into a number of parallel narrow-band channels, each channel having a different centre carrier frequency. The narrow-band channels are often termed “sub-carriers” or “sub-channels”, which terminology shall be used interchangeably herein.

In OFDM the sub-carrier pulses are generally rectangular and typically implemented using an Inverse Fast Fourier Transform (IFFT). The spacing of the sub-carrier centre frequencies is selected and implemented using IFFT such that at a particular sub-carrier frequency all other sub-carrier signals are zero or at least in practice close to zero. This reduces the likelihood of direct interference between sub-channels.

The multiple sub-carrier approach also ameliorates interferences due to multi-path transmissions since it spreads out a frequency selective fade over many symbols and the interleaving effectively randomises burst errors so that instead of several adjacent symbols being completely obscured, many symbols are only slightly distorted. Thus, forward error correction may be used for efficient data recovery. Any frequency selective fade only tends to obscure a single sub-carrier, and because adjacent symbols are distributed over different sub-carriers it is unlikely for a series of adjacent symbols to undergo degradation due to the same frequency selective fade. Additionally, since a frequency selective fade tends to obscure only a single sub-carrier channel equalisation is simplified. This is because each sub-carrier experiences a quasi-flat fading and therefore can be independently equalised in power and phase. OFDM has become very popular since it allows the transmission of wide-band signals over highly frequency selective channels at low receiver implementation costs. In particular, the cost of implementing complex equalisation can be dramatically simplified or even made unnecessary if differential encoding is used.

A block diagram of a COFDM transmitter modem 100 in accordance with a first embodiment of the present invention is illustrated in FIG. 1. The OFDM processor unit 102 includes a virtual sub-carrier adder 104, an IFFT processor 106 and a guard interval adder 108.

Raw data 116 is input into forward error correction unit 118 which adds additional data to the raw data stream 116 to protect it against distortion imposed by the communications channel and also by modem and transceiver hardware, and allow for sufficient information such that any distortion may be corrected by a cooperating receiver. Generally speaking, OFDM converts frequency selective fades into simple flat fades across individual sub-channels. However, forward error correction is still required to protect each individual sub-channel and allow recovery of information lost in the faded sub-carriers. Without forward error correction, frequency selective fading may result in high bit error rates of the order of 1 in 10.

The FEC coded data is input to an interleaver 120 which scrambles the data across frequencies in order to improve its resilience to frequency selective fades. The symbol mapper 122 encodes the data stream into a channel coding format to improve the spectral efficiency of the transmitted data signal, and which in the illustrated embodiment is quaternary phase shift keyed (QPSK). However, there is no restriction on the modulation scheme which may be used to modulate each sub-carrier. For example, one or more sub-carriers can be modulated with different modulation schemes even to the extent that each sub-carrier can be modulated with a different modulation scheme to the other sub-carriers.

The virtual sub-carrier adder 104 adds “dummy” sub-carriers into the OFDM modulation scheme for protection against non-ideal filtering characteristics of the modem, transceiver hardware or communications channel, and also to reserve channels for pilot sub-carriers or additional data if required.

The IFFT processor unit 106 performs the inverse fast Fourier transform which forms the orthogonally spaced OFDM sub-carriers, and the guard interval adder 108 inserts a guard interval, for example a pause in transmission or a repeat of part of the data previously transmitted, into the OFDM signals 110 and 112 in order to protect against inter-symbol interference.

The guard interval is normally added after the IFFT stage and is added in the time domain of the multiple OFDM signals 110, 112, in order to mitigate and preferably prevent multi-path effects and inter-symbol interference. The guard interval may consist of zero data, or commonly a cyclic repetition of a part of the symbol sequence already transmitted. The latter approach allows symbol timing and synchronisation to be more easily recovered at the receiver. In order to avoid multi-path effects, the duration of the guard interval is made greater than the delay spread of the communications channel.

It should be noted that in the illustrated embodiment the outputs (real and imaginary) of the inverse fast Fourier transform are assigned to the I and Q signals, I110 and Q112.

Respective I and Q signals are input to a peak-to-average ratio (PAR) reduction unit 124 which applies techniques such as clipping to reduce the peak-to-average ratio of the OFDM I and Q signals.

The I and Q OFDM signals then have a raised cosine window 126 applied to them, which performs raised cosine filtering in order to reduce, and preferably inhibit, spectral leakage into adjacent channels.

In accordance with one embodiment of the invention, the OFDM system may have many more sub-carriers, for example 486, a much larger fast Fourier transform size, for example 512-points, and occupy a much greater bandwidth, for example 356 megahertz, than prior art systems of which one example is the IEEE 802.11a standard having 52 modulated sub-carriers, a fast Fourier transform size of 64-points and a signal bandwidth of only 20 megahertz. In order to cope with a signal bandwidth of 356 megahertz, the sub-carrier frequencies are at millimetre-wave frequencies (for example 40 GHz or 60 GHz short-range (10-100 metres) radio links, which means that the sub-carrier spacing can be increased to 0.7 megahertz for example in order to compensate for different channel conditions compared to lower frequency centre sub-carrier frequencies, for example at a shorter channel or coherence bandwidth. Embodiments in accordance with the present invention enable higher speed COFDM modems than were previously available, for example the highest frequency of operation of a prior art COFDM modem is 54 megabits per second.

Turning now to the OFDM processor unit 102, an embodiment of the invention comprises a multiplexed architecture as illustrated in FIG. 2. The architecture illustrated in FIG. 2 comprises first and second processor channels (a) and (b).

Prior to the multiplexed processor unit 102 the data is split into blocks of data. A switch 140 switches even and odd numbered blocks between processor channels (a) and (b) respectively. In the illustrated embodiment blocks of data are input into a register 142 prior to being loaded into the corresponding virtual sub-carrier adder 104. The register 142 may be separate from the virtual sub-carrier adder 104 or be integral therewith. Optionally, the data blocks may be loaded directly into respective virtual sub-carrier adders 104a and 104b. As one incoming block, an even-numbered block in the illustrated example, is loaded into register 142a an odd-numbered block having previously been loaded in register 142b is processed by virtual sub-carrier adder 104b. The clock and processing rate of the registers 142 and virtual sub-carrier adders 104 are such that when a new block is to be switched into a respective processing channel the register 142 and virtual sub-carrier adder 104 are ready to receive a new block of data.

Blocks of data from each virtual sub-carrier adder 104a and 104b are forwarded to IFFT processor units 106a and 106b respectively. Each IFFT 106a and 106b operates on respective even and odd numbered blocks of data respectively, and respective IFFTs operating out of synchronisation with the other.

FIG. 3 illustrates the relative timing between the odd and even data blocks at each end of the COFDM modem chain. Raw data 116 comprising odd and even data blocks 2 and 4 are input to switch 140 which alternately switches them into processing chain (a) and (b). At time t₁ odd data block 2 is input to processing chain (a) and at the beginning of the even data block 4 (time t₂) switch 140 points to modem chain (b). At time tₙ output switch 142 points to the output of modem chain (a) and processed odd data block 6 is output. At time tₙ₊₁ switch 142 points to the output of modem chain (b) and processed even data block 8 is output to form a part of a processed data stream 10.

In the described embodiment the IFFT utilises a pipelined architecture and operates on blocks of data each of length N_{FFT} where N_{FFT} is the Fast Fourier Transform (FFT) size. For the example described herein, the IFFT has to be calculated on blocks of 512 samples. The time taken to calculate a 512-point FFT is typically 1-10 microseconds which is about equal to the OFDM symbol duration for the present example. The memory requirements for a 512-point FFT processor unit is approximately 1.3 kilobytes and using a pair of multiplex IFFT stages speeds up chip performance

An architecture using two multiplexed processing channels reduces the required IFFT processing time by approximately a factor of two. In general, an N multiplexed architecture reduces the required IFFT processing time by approximately a factor N.

The illustrated embodiment includes a guard interval adder 108 within the modem 100. The multiplexed architecture illustrated in FIG. 2 has respective guard interval adders 108a and 108b for respective processing channels (a) and (b). Each guard interval adder inserts a guard interval into the COFDM signal output from the IFFT. The guard interval consists of a portion of each COFDM symbol appended to the end of the same symbol, known as the cyclic prefix (CP). The use of a cyclic prefix advantageously simplifies COFDM symbol time and synchronisation in a modem receiver for reconstructing the signal. The addition of a guard interval including COFDM signal ameliorates inter-symbol interference, thereby providing a less noisy and error prone communications system. Optionally, the guard interval comprises a pause in signal transmission achieved by setting a zero signal voltage level.

The COFDM signal output from the IFFT 106 is a continuous stream of COFDM symbols, and the modem 100 stores the incoming streaming COFDM symbol data whilst the guard interval is added to the data stream. As successive COFDM symbols flow into the guard interval adder 108 the amount of memory required for storing the COFDM symbols increases as a backlog of data builds up due to the fact that the guard interval adder is adding the guard interval, that is to say the incoming stream of data is stored whilst the guard interval is added. The amount of memory required increases indefinitely during the operation of the modem.

Although it would be possible to route a modem synchronisation signal back to the data source in order to control or possibly temporarily halt the transmission of data to the modem when the guard interval is being written, such a technique would adversely affect the data rate of the modem.

The present applicant has recognised that the problem may be addressed by operating the guard interval adder at a higher data rate than the COFDM signal originating from the IFFT. Table 1 below sets out how the clock rates vary throughout the COFDM sectors for a raw data signal input at a clock frequency of 270 MHz to the forward error correction unit. As can clearly be seen from the table, the data in the guard interval adder is clocked at 1.25 times the clock rate of the IFFT. This is in order to insert the guard interval into a data block within the same time period that the data block is processed in the IFFT and avoid having to stop IFFT processing to allow time to insert the guard interval.

TABLE 1

| COFDM Modem Sector | Sector Clock Rate |
|---|---|
| FEC | 270 MHz input |
| | 540 MHz output |
| Interleaver, DQPSK mapping | 540 MHz |
| Add virtual subcarriers/ | 540 MHz input |
| pilot tones | 540/486 * 512 = 568.89 MHz output |
| IFFT | 568.89 MHz |
| Guard interval adder | 568.89 MHz input |
| | 568.89/512 * 640 = 711.11 MHz output |
| PAR reduction, raised | 711.11 MHz |
| cosine windowing | |
| IQ upconverter | 711.11 MHz |

The clock-rate of the guard interval adder is calculated on the basis that the same coded bit rate (540 megabits) must be achieved but with the addition of a null in effective symbol transmission during the guard interval. For the illustrated embodiment the clock rate is given by the following relationship:

$${f}_{clk - gi} = \frac{{f}_{clk - fft} \times {T}_{s}}{{T}_{fft}}$$

where Tₛ, is the total OFDM symbol duration including a guard interval 1.8 microseconds and T_{fft} is the duration of the FFT segment in an OFDM symbol (1.44 microseconds). f_{clk-gi} is a new clock rate after the guard interval has been added and f_{clk-fft} is the clock rate at the IFFT stage. Thus, it can be seen that guard interval adder utilises two separate clock signals.

A detailed description of the operation of guard interval adder in accordance the illustrated embodiment of the invention will now be made with reference to FIG. 4 of the drawings. The guard interval adder 108a/b comprises an input switch 152 which is toggled every 1.44 microseconds in order to alternately input every 512 samples of the COFDM signal from the IFFT 106a/b in respective input registers 154 and 156. The term “commutator switch” is often used to indicate a switch that is continually toggled between two (or more) states. The input registers 154 and 156 fill up with the clock rate (540 megahertz) of the COFDM signal. The input registers 154 and 156 operate to receive and store data coming into the guard interval adder at lower clock frequency than it is to be output.

Each input register 154 and 156 operates on 512 data points, and are loaded into respective input registers according to the state of switch 152 which toggles between the two banks of registers every 512 data points (data block). Once 512 data points have been loaded into an input register 154/156, they are copied into an output register 170/172 via a buffer register 162/164. Switches 158 and 160 serve to isolate buffers 162 and 164 from the input registers respectively when not receiving data, and switches 166 and 168 serve to isolate them from respective output registers 170 and 172 when not copying data into the output registers.

Each output register 170 and 172 contains 640 data points, of which 512 represent data points and the remaining 128 represent the guard interval. The 128 guard interval bits may be null or zero bits, and the output registers are configured so that the 512 data points are output first followed by the 128 null or zero value guard interval bits. In an optional embodiment, the output registers are configured to repeat the last 128 data points of the 512 data block when outputting data. This may be by copying the last 128 data points into the extra register locations before outputting the data, or configuring the register such that the last 128 data points are re-read into the register and output after the last of the 512 data points. The data from registers 170 and 172 is output at a fast clock rate 178 of 711.11 MHz to toggle switch 174, which is greater than the guard interval adder input clock rate 176 of 568.89 MHz.

FIG. 5 illustrates where in the illustrated embodiment processing chain virtual sub-carriers are added to the data signal to form a part of the COFDM output signal. Virtual sub-carriers are included in COFDM signals for a number of reasons. For example, they may be placed at either end of the COFDM signal frequency spectrum to protect the signals against non-ideal filtering characteristics. They may also be included in the COFDM signal should pilot tones be required for future applications. In the illustrated embodiment 26 virtual sub-carriers are included in the COFDM signal (13 sub-carriers at each end of the COFDM signal). Each virtual sub-carrier occupies 694.44 kilohertz of spectrum giving a total bandwidth of 18.0556 megahertz for all 26 sub-carriers. Thus, including 486 modulated sub-carriers there are 512 sub-carriers in total.

As illustrated in FIG. 5, the virtual sub-carrier adder 104 is located between the DQPSK mapper 122 and the IFFT 106 stage. Locating the virtual sub-carrier adder 104 prior to the IFFT 106 stage means that the virtual sub-carriers are added at the latest stage reasonable in the modem processing architecture. This is advantageous since the data-streaming nature of the forward error correction, interleaver phase and DQPSK symbol mapper are not interrupted. If the virtual sub-carrier adder 104 was located between or in front of the forward error correction module 118, interleaver 120 or DQPSK symbol mapper 122 then additional synchronisation circuitry would be required in order to synchronise and compensate for the additional data being added to the data streaming signal. This would increase the complexity of the modem design, and potentially reduce its operating speed.

Since the virtual sub-carrier adder 104 is adding data to the incoming bit-stream the output clock rate must be greater that the input clock rate in order to maintain the information data rate, and this can be seen from Table 1 above where an input signal clocked at 540 MHz is clocked at 568.89 MHz in the virtual sub-carrier adder.

From a general perspective the operation of the virtual sub-carrier adder 104 with two different clock rates is implemented by inputting two blocks of CODFM data into input shift registers, and interlacing the two blocks with virtual sub-carriers by the use of suitable means controlled output switches. The speed of data transfer occurs at the slower clock rate when inputting data into the shift registers and at the high clock rate when outputting the data.

Referring now to FIG. 6, the virtual sub-carrier adder 104 operates on blocks of 486 data points where each data point represents the amplitude and phase of a single sub-carrier. These points are loaded into an input register 181 or 182 according to the state of the input switch 104. The input switch toggles between the two banks of registers. Once 486 points have been loaded into the input register 181/182 at the slow clock rate 183, they are copied into respective output register 186/187 via a buffer register 184/185. Switches 188 and 189 serve to isolate buffers 184 and 185 respectively from respective input registers 181 and 182 when not receiving data from the input registers, and likewise switches 190 and 197 isolate respective buffers 184 and 185 from output registers 186 and 187. The output registers 186 and 187 each contains 512 points (corresponding to the 512 COFDM sub-carriers), 486 of which represent data, and 26 of which represent virtual sub-carriers (usually null/zero data). The output registers can be configured to insert the virtual carriers at any suitable point in the 486 points, but typically are inserted before and after the 486 data sub-carrier points. The data in the output registers 186/187 is clocked out at a fast clock rate 192 of 568.89 MHz and is fed to the output toggle switch 193.

Adding the virtual sub-carriers as late as possible into the data stream means the data can be separated out into COFDM blocks as late as possible in the processing chain which allows the FEC core 118, interleaver core 110 and DQPSK mapper core 122 cooperate on streaming data rather than blocks of COFDM data. The synchronisation of data flow between each of the individual cores is simplified since there is no need for sensing any COFDM block delay from each individual core.

The IFFT and FFT cores may be implemented using commercially available cores from any one of a number of field-programmable gate array (FPGA) manufacturers. Standard radix-4 architectures may be used for 512 point or 1024 point IFFT and FFT processing.

The IFFT processor 106, a butterfly module 200, is illustrated in FIG. 7. The butterfly module 200 contains 9 butterfly units 202a-202i. Each butterfly unit contains a shift register 204a . . . i. Each butterfly unit 202a. . . i includes a radix-2 butterfly element 206a. . . i, controlled by a butterfly controller module 208. Transfer of data from one butterfly element 204 to another butterfly element 204 undergoes a propagation delay W^{k}_{N}210.

Each of the nine butterfly units 202a-202i in the IFFT chain do not begin performing arithmetic until their associated shift register 204a-204i. Consequently, the start up conditions for the butterfly module need to address this requirement. For the described embodiment, each butterfly unit 202a-202i transfers data from its data input port to the input port of its corresponding shift register 204a-204i without any intervening processing. In this regard, the butterfly modules may be considered as acting as a simple wire connection between their respective data input ports and the data input port of their corresponding shift registers.

Configuring the butterfly module 200 start up conditions may be achieved by setting a flag when the first data element flowing into the IFFT module has reached the butterfly module 200. Each butterfly unit 202a-202i needs to switch state at the correct time, namely when the data point has reached their input. A problem is that there is a finite propagation delay through the IFFT chain as the data propagates through the and other parts of the circuitry. For a typical IFFT processor such as used in the described embodiment, the first half of the IFFT is loaded into the first shift register, i.e. the first 256 samples in the present embodiment. So, this delay is built in as part of the IFFT chain of shift registers which for the 512-point IFFT described herein start at 256 samples and decrease by power 2 as 256, 128, 64, 32, 16, 8, 4, 2, 1. There are also further delays caused by the finite time for signals to propagate through various parts of the circuitry. Thus each shift register for respective butterfly units must start responding at different times during the IFFT calculation cycle. To address this problem the IFFT processor unit 106, in particular the butterfly module 200 is simulated for example using CAD synthesis. The delays at each stage of the IFFT chain are calculated and recorded. Table 2 below sets out the delays.

TABLE 2

| Butterfly | |
|---|---|
| Switching Flag | Elapsed time (in clock cycles) after the counter |
| Signal | has started before raising the flag |
| BF1 | 256 |
| BF2 | 256 + TD1 + 128 = 384 + TD1 |
| BF3 | 448 + TD1 + TD2 |
| BF4 | 480 + TD1 + TD2 + TD3 |
| BF5 | 496 + TD1 + TD2 + TD3 + TD4 |
| BF6 | 504 + TD1 + TD2 + TD3 + TD4 + TD5 |
| BF7 | 508 + TD1 + TD2 + TD3 + TD4 + TD5 + TD6 |
| BF8 | 510 + TD1 + TD2 + TD3 + TD4 + TD5 + TD6 + TD7 |

A butterfly controller 208 is configured with the delays and applies the delays from a start flag 212 to send an activation signal 214 to respective butterfly units 202a-202i corresponding to when the appropriate input data arrives.

The operation of the butterfly controller 208 will now be described with reference to FIG. 8.

The butterfly controller 208 comprises a 9 bit counter 220, memory 222 which in the illustrated example is read-only memory and a decision module 224. The outputs of the decision module BF1-BF8 are the butterfly element activation signals 214a-214h. Although there are 9 butterfly elements there are only 8 activation signals since the 9^{th} butterfly element merely stores a signal sample and does not require a switching condition.

Start flag 212 is input to 9 bit counter 220, and when the start flag goes high the counter is reset and begins counting from 0. The first butterfly element activation signal 214a is raised on pin BF1 when the counter reaches 256.

In an optional embodiment, differential encoding may be employed. This is advantageous since coherent COFDM requires a channel estimator which must correctly determine the magnitude and phase response of the channel for each individual sub-carrier. As with the afore described embodiment, this is usually achieved using pilot sub-carriers with low inaptitude and phase and with an interpellation of algorithm.

COFDM simplifies the task of equalisation because the channel estimation can be broken down and applied to each sub-carrier individually. However, channel estimation based on pilot terms an equalisation increases the computational load and would therefore reduce bandwidth efficiency. For example, 8% of the available bandwidth allocated to a single IEEE 802.11a channel is spent on pilot tones, which is typical for wideband COFDM systems. The use of differential encoding means that it is possible to avoid equalisation altogether and greatly simplify the complexity of the modem transceivers and preferred bandwidth efficiency by sacrificing approximately 1-3dB of signal-to-noise ratio. Differential encoding operates by encoding data between either successive symbols or by encoding data between the adjacent sub-carriers by sacrificing a signal sub-carrier as the initial phase reference.

The reduction of complexity afforded by differential encoding is beneficial for embodiments of the present invention as it mitigates the requirement for high speed channel estimation in the modem hardware. Additionally, differential encoding is particularly attractive for ultra-wideband COFDM systems because the phase rotations induced by filters and the channel itself can be very large. The use of differential encoding also enhances a signal acquisition speed, phase synchronisation and tracking for time-selected channels since for specific demodulator architectures the required for carrier recovery can be significantly reduced or completely eliminated altogether.

According to a second embodiment of the present invention, an alternative and preferred design for the transmitter portion of a COFDM modem will now be described with reference to FIG. 9. In the alternative design, rather than restrict the use of a parallel architecture to those functional parts of the modem which need to carry out the highest level of processing, the idea of using a parallel architecture has been extended to substantially the whole modem. This has the advantage that other functional components may be operated at a lower clock rate, reduced by a factor determined by the number of parallel channels—four in this example—making for a less expensive implementation and, according to the target overall bandwidth of the modem, a more realisable design in practice.

Referring to FIG. 9, which has been divided into two interlinking FIGS. 9a and 9b for convenience of presentation, an engineering diagram is provided showing the structure of a transmitter portion of the COFDM modem based upon four parallel data processing streams. Data input at 900, e.g. a data stream from a TV camera, is buffered (902) and input to a demultiplexer 904 operable to identify data blocks within the input stream 900 and to split the input data stream 900 into four data streams on the basis of the identified data blocks, as in the first embodiment described above. This division of the input data stream 900 by the input demultiplexer 904 is carried out in the time domain, e.g. as a cyclic distribution of data blocks between streams as the blocks are received. However, there are numerous ways in which to distribute data blocks, or parts of data blocks, between the four data streams, as would be apparent to a person of ordinary skill in this field.

To ensure that data flows through the four data processing streams in a synchronised manner, an appropriate differential time delay is applied to three of the four outputs of the input demultiplexer 904 by buffers 906 to take account of the time divisional way in which the input stream 900 was split. In the example shown in FIG. 9, it has been assumed that input data blocks have been distributed between the streams uniformly, in time, by the demultiplexer 904. The appropriately synchronised streams are input to forward error correction (FEC) modules 908, similar to those (118) used in the first embodiment described above, to add additional data to the respective data streams to enable forward error correction to be implemented in a corresponding COFDM receiver modem, to be described later in this specification according to a third embodiment of the present invention.

The outputs of the FEC modules 908 are input, via buffers 910, to respective interleaver modules 912, similar to those (120) used in the first embodiment described above, to scramble data in each stream across different sub-carrier frequencies whereupon, after buffering (914), symbol mappers 916 similar to those (122) of the first embodiment modulate each data stream into a channel coding format, in this example using differential quaternary phase shift keying (DQPSK). The four I channels and four Q channels output from the mappers 916 are, optionally, multiplexed together, in this example as pairs into four streams, by multiplexers 920, resulting in two I channel streams and two Q channel streams. This technique for combining channels may be advantageous in providing a further level of interleaving to that provided by interleavers 912. Different combinations of the I or the Q channels may be implemented at this stage, according to the number of parallel data streams.

Each stream of multiplexed I and Q channels is input to a different virtual sub-carrier adder module 922, similar to that (104) used in the first embodiment, to add “dummy” sub-carriers into the COFDM modulation scheme. After buffering (924), the two I channel streams and the two Q channel streams are input to two different inverse fast Fourier transform (IFFT) modules 926, similar to those (106) used in the first embodiment. Each of the two buffered (928) outputs of the two IFFT modules 926 are input to a respective guard interval adder 930, similar to those (108) used in the first embodiment. The buffered outputs of the four guard interval adders 930 are then input to dual port memory (DPM) modules 934 to enable the data rate (177.77 MHz in FIG. 9) of the channel streams to be changed to a higher data rate (355.55 MHz in FIG. 9). Each of the two higher data rate I channel and Q channel outputs are then fed in a time-division multiplexed fashion via switches 936 to two respective digital to analogue (DAC) converters 938, one for the I channel and one for the Q channel. Analogue signals representing the I and Q channel data streams are output (940) by the respective DAC modules 938 and may, thereafter, then be fed to wireless or other forms of transmitter (not shown in FIG. 9).

In the diagram of FIG. 9, each of the modules in one of the data streams is shown with corresponding clock frequencies, indicating, where appropriate, that the data rate at which data enters the module is not necessarily the same data rate as is output from the module. The clock frequencies shown for modules of the one data stream in FIG. 9 are intended to apply to the other modules of the same type in the other data streams, but the clock frequencies have been omitted for the other three data streams shown in FIG. 9, for ease of representation. An ability to vary the data rate of signals as they progress through the modem architecture of FIG. 9 is particularly advantageous, enabling delays during processing to be minimised, particularly when adding guard intervals (930) or virtual sub-carriers (922) to a signal for example. This technique of using different data rates was adopted for the first embodiment of the present invention, described above. However, in comparison with the clock rates required for the architecture in the first embodiment, for the fully parallel architecture of this preferred second embodiment, the clock rates of the individual modem blocks (such as the guard interval adder 930, or the IFFT 926) are reduced by a factor determined by the number of parallel channels—four in this case. For example, in Table 1 above, the interleaver 120 in the first embodiment was driven by a 540 MHz clock. However, with two parallel interleavers, the clock rate per interleaver would be halved, dropping to 270 MHz. The design can be extended to more than two channels. So with four channels, as used in this preferred second embodiment of the present invention, the clock rate per interleaver 912 drops to 135 MHz, which is easier to achieve using current field-programmable gate array (FPGA) technology. For the architecture shown in FIG. 9, which uses four parallel streams, the corresponding required clock rates are given in Table 3, as follows:

TABLE 3

| COFDM Modem Sector | |
|---|---|
| (Quad-path design) | Sector Clock Rate |
| FEC (908) | 67.5 MHz input |
| | 135 MHz output |
| Interleaver (912), DQPSK | 135 MHz |
| mapping (916) | |
| Add virtual sub-carriers/ | 135 MHz input |
| pilot tones (922) | 540/486 * 512/4 = 142.22 MHz output |
| IFFT (926) | 142.22 MHz |
| Guard interval adder (930) | 142.22 MHz input |
| | 568.89/512 * 640/4 = 177.78 MHz output |
| PAR reduction, raised | 177.78 MHz |
| cosine windowing | |
| IQ upconverter (934) | 177.78 MHz |

The clock frequencies list in Table 3 may require the use of fractional-N synthesisers to realise these frequencies, owing to the fractional relation between the individual modem block clock frequencies. More practically related clock frequencies, that allow the use of integer-N synthesisers, could be achieved by the use of handshaking protocols. In particular, the clock frequencies list in Table 3 represent streaming modem operation when preferably there are no pauses in the data processing in the modem. In a handshaking design there may be periods in the data transmission (between the internal modem blocks) whereby valid data is not being transmitted. In a simplest form of handshaking design, the individual modem blocks are operable to flag when valid data is present at their output terminals so that a recipient modem block is able to detect when to process the data. By manipulating the amount of data and thus the data-rate of each modem block, the clock frequencies driving each modem block can be adjusted. To achieve the optimum would require a single clock delivered to the modem which could be realised with relatively simple phase locked loop (PLL) architectures. Such an implementation is achieved in practice by adding an extra terminal connecting adjacent modem blocks internally to the modem chip design. The voltage on this terminal might (for example) rise to logic high (e.g. 3 V) when valid data is present, and fall to logic low (e.g. 0 V) when no data is present. In practice many of the modem blocks will require some form of handshaking, in particular the virtual sub-carrier adder 922 and guard interval adder 930 because these blocks add additional data (other than that coming from the data source) and thus impact on the clock frequency requirements.

In a preferred design for the guard interval adder 930, and in principle also the vitrual sub-carrier adder 922, dual port memory (DPM) devices may be used, conveniently, to achieve a step up or a step down in data rate, as would be apparent to a person of ordinary skill in this field. A dual port memory is a static memory core with independent input and output ports, each with its own separate addresses, data and control signals. Dual port memory devices are typically used to connect two devices running at different clock frequencies. The advantage of a dual port memory is that data are accessible by either port with no constraints. Since the two clock domains are isolated, the device can simultaneously process and output data whilst inputting data.

In a guard interval adder 930 implemented using DPM devices, in keeping with the preferred parallel processed design, data comprising of one block of COFDM is first loaded into a first dual port memory bank at a slower clock rate. Once this has taken place an input switch moves position so that data is now loaded into a second bank of memory. Simultaneously, whilst data is being fed into one bank of dual port memory, data is also read out of the other bank of dual port memory. However, data is read out from the other bank of memory at a faster clock rate corresponding to the extra data—the guard interval—which may be cyclic prefix data.

A preferred architecture for the receiver portion of a COFDM modem, designed to cooperate with a modem having a transmitter portion as described above according to the second embodiment of the present invention, will now be described with reference to FIG. 10 according to a third embodiment of the present invention. This receiver portion is intended to receive signals output by a corresponding transmitter modem according to the second embodiment and to demodulate them, applying any necessary any achievable corrections to the data stream as required, and to output a data stream corresponding to that originally input to the corresponding transmitter modem. In general, the architecture of the receiver portion is required to mirror the architecture of a cooperating transmitter, for example in the number of data processing streams employed. One reason for this is that the data applied by the forward error correction modules 908 in the transmitter are unique to the respective data processing stream and hence the receiver is required to be able to recreate the equivalent data processing streams in order to remove the forward error correction.

Referring to FIG. 10, which has been divided into two interlinking FIGS. 10a and 10b for convenience of presentation, an engineering diagram is provided showing the structure of a receiver portion of the COFDM modem based upon four parallel data processing streams. Digital signals are received at inputs 1000 for the I and Q channels, having already been converted in analogue to digital converters (not shown in FIG. 10) preferably at the same data rate as was output by the transmitter portion of the modem of the second embodiment, 355.55 MHz in this example, and demultiplexed by means of switches 1002 into dual port memory modules 1004 to enable the data rate to be reduced, to 177.77 MHz in this example (the minimum clock rate for this four channel architecture without the use of handshaking), for each of four data processing streams.

Firstly, the additional bits added by the transmitter (guard interval adder 930) to protect against multipath effects are removed from each data stream by guard interval removers 1006. Preferably, the architecture of the guard interval remover 1006 is similar to that of the guard interval adder 930 of the corresponding transmitter, except in that when removing a guard interval, for example a block of 128 samples from a 640-sample block, the 640-sample block is read into the guard interval remover 1006 at a faster clock frequency than is required to read the smaller 512-sample block out. The buffered (1008) outputs of the guard interval removers 1006 are input to two fast Fourier transform (FFT) modules 1010 to convert the I channel and Q channel signals back into the frequency domain. The minimum frequency is now 142.22 MHz. The buffered (1012) outputs of the FFT modules 1010 are now input to virtual sub-carrier removers 1014 to remove from each data stream the zero-amplitude samples that are now redundant and do not carry any data. These samples were placed there by the transmitter (virtual sub-carrier adders 922) to allow for non-ideal filtering characteristics.

After the virtual sub-carriers have been removed (1014), the I and Q channels streams are demultiplexed in demultiplexers 1018 and recombined to form the I and Q channels as they were before mixing by the transmitter modem of the second embodiment in multiplexers 920. The recombined I and Q channels are then input to DQPSK de-mappers 1022 to remove the modulation applied to each of the sub-carriers in the transmitter portion (by DQPSK mappers 916). The demodulated outputs of the demappers 1022 are then input to hard decision detectors 1026, each operable to detect an incoming signal and to make a decision as to what the original transmitted data bit was. The purpose of the hard decision detector 1026 is essentially to decide if the transmitted bit was a logic ‘1’ (corresponding to a positive signal voltage) or a logic ‘0’ (corresponding to a negative signal voltage). Preferably, to gain further signal-to-noise ratio performance, a so-called soft-decision detector may be used in place of each hard decision detector 1026 in which not only the polarity of the signal voltage is measured but the difference between this voltage and a decision threshold voltage. This difference can be used by a corresponding Viterbi decoder 1034 later in the data stream to raise confidence in each of the decoded bits and thus improve the estimate made by the Viterbi decoder 1034.

The resulting four bit-streams output by the hard decision detectors 1026 are then passed to respective deinterleaver modules 1030. The deinterleaver 1030 removes the interleaving that was imposed (by interleavers 912) in the transmitter to enable more effective forward error correction. Finally a forward error correcting (FEC) Viterbi decoder 1034 takes away the forward error correction algorithm that was applied to the data streams by the transmitter (by FEC modules 908). The recovered data streams are then multiplexed back into a single stream in a multiplexer 1038 and the resultant data stream is output, 1040, from the modem. In operation, this output data stream (1040) should correspond to the data stream received at the input 900 of a cooperating transmitter modem according to the second embodiment of the present invention described above.

The use of four parallel streams in the receiver has effectively reduced the required clock rates of the individual receive modem functions (described above). In the example described, the deinterleaver is clocked at 135 MHz, which without the parallel architecture would have been 270 MHz. This reduction in clock frequency allows the receiver to not only be prototyped on existing FPGA technology, but allows the architecture to receive very high bandwidth COFDM signals.

In each of the first, second and third embodiments of the present invention described above, the apparatus is in practice provided with functionality, not shown in the figures, to achieve synchronisation between transmitter and receiver of frequencies. In general, conventional techniques are applied to achieve synchronisation. However, the use of a parallel modem architecture as in preferred embodiments of the present invention allows synchronisation to be achieved on high bandwidth COFDM.

There are a variety of ways of achieving synchronisation in COFDM systems. These can be data-aided and non-data aided. In the receiver according to the third embodiment described above, synchronisation can be achieved in the time domain (pre-FFT) or in the frequency domain (post-FFT), or a combination of the two. The use of a parallel modem architecture described here may have an advantageous impact on how synchronisation is achieved, depending upon what synchronisation techniques are adopted. For example, with parallel data streams there may be more time available for the synchronisation to be achieved because the symbol period of a COFDM signal has been elongated by a factor depending upon the number of parallel channels implemented in the modem. For example, in the transmitter embodiments, any additional synchronisation information embedded into the COFDM can be implanted after the input data stream has been demultiplexed into the parallel channels at a slower clock rate. In the receiver embodiment, the frequency and timing error is going to be the same for each of the parallel channels. Therefore, synchronisation algorithms implemented in the receiver need only extract information from one of the parallel channels, and not from all of the channels.

Insofar as embodiments of the invention described above are implementable, at least in part, using a data processing apparatus, it will be appreciated that a computer program for implementing at least part of the described modems and methods of operation and is envisaged as an aspect of the present invention. The programmable data processing apparatus may be any suitable apparatus, system or device, for example, the computer system may be a Field Programmable Gate Array (FPGA), a Digital Signal Processor or a microprocessor. The computer program may be embodied as source code and undergo compilation for execution on a computer, or may be embodied as object code, for example.

Suitably, the computer program can be stored on a carrier medium in computer usable form, which is also envisaged as an aspect of the present invention. For example, the carrier medium may be solid-state memory, optical or magneto-optical memory such as a readable and/or writable disk for example a compact disk and a digital versatile disk, or magnetic memory such as disc or tape, and the computer system can utilise the program to configure it for operation. The computer program may be supplied from a remote source embodied in a carrier medium such as an electronic signal, including radio frequency carrier wave or optical carrier wave.

In view of the foregoing description of particular embodiments of the invention it will be appreciated by a person skilled in the art that various additions, modifications and alternatives thereto may be envisaged. For example, the sub-carrier modulation scheme need not be as explicitly described. The choice of sub-carrier modulation scheme is a trade-off between a data-rate requirement (or bandwidth) and the transmission channel robustness. With IEEE 802.11a, there are a number of sub-carrier modulation schemes available for the transmitter depending upon the required bit-rate of the channel response. For noisy channels or when the transceivers are spaced relatively far apart, the system will switch to a lower order modulation scheme such as QPSK. The increased bandwidth efficiency of schemes such as 64 QAM is at the expense of increased transmit power requirements and also heightened sensitivity to non-linearity and oscillator phase noise. The choice of sub-carrier modulation scheme influences the required signal-to-noise ratio and bandwidth characteristics of the transmission link. As a result, the choice of sub-carrier modulation scheme is important for millimeter-wave COFDM due to hardware performance restraints. Higher order modulations schemes such as 64 QAM are more sensitive to peak clicking and peak-windowing and generally require greater back-off from the power amplifier 1 dB compression point. Therefore, schemes such as DQPSK have generally been adopted for millimetre-wave COFDM systems.

Embodiments of the invention may be implemented in software, firmware or hardware or any combination of two or more of software, firmware and hardware.

Although preferred embodiments of the present invention have been described in the context of a transmitter and receiver modem, the skilled person will nevertheless recognize that the principles disclosed herein may be applied to other applications for processing data, and is not limited to modems or communications systems.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived therefrom. In particular, with reference to the appended claims, features from dependent claims may be combined with those of the independent claims and features from respective independent claims may be combined in any appropriate manner and not merely in the specific combinations enumerated in the claims.

### REFERENCES

[1] “Get IEEE 802” IEEE home page, http://qroupa.ieee.org/groups/802/11/index.html
[2] R. W. Chang “Synthesis of Band-Limited Orthogonal Signals for Multi-Channel Data Transmission,” Bell Systems Technical Journal, Vol. 45, EP. 1775-1796, December 1966
[3] B. R. Saltzburg, “Performance of an Efficient Parallel Data Transmission System,” IEEE Transactions on Communications, Vol. COM-15, No. 6, PP. 805-811, December 1967
[4] S. B. Weinstein and P. M. Ebert, “Data Transmission Frequency-Division Multiplexing using the Discreet Fourier Transform,” IEEE Transactions on Communications, Vol. COM-19, No. 5, PP. 628-634, October 1971
[5] A. Peled and Ruliz, “Frequency Domain Data Transmission using Reduced Computational Complexity Algorithms,” Proc. IEEE Int. Conf. Acoust. Speech and Signal and Processing, Denver CO., PP. 964-967, 1980
[6] http://www.ofdm-forum.com/library, “OFDM Basics and History”, Richard Van Nee

1-14. (canceled)

15. An apparatus for processing a high data rate signal, comprising:
a plurality of data processing units;
a switching arrangement to receive a first signal at a high first data rate and to switch said first signal between inputs of said plurality of data processing units at regular time intervals,
wherein each of said plurality of data processing units is operable to process said first signal at a second data rate less than said high first data rate to form respective second signals; and
a combining arrangement to switch between outputs of said plurality of data processing units to form a processed high data rate signal from a combination of said respective second signals.

16. The apparatus of claim 15, wherein said switching arrangement is operable to process a streaming first signal into blocks of data and to switch blocks of said first signal cyclically between the inputs of said plurality of data processing units.

17. The apparatus of claim 15, wherein each of said plurality of data processing units includes first and second modules, said first module being operable at a third data rate and said second module being operable to receive a signal output from said first module and to process said received signal at a fourth data rate greater than said third data rate for inserting data points into said received signal to form a third signal.

18. The apparatus of claim 17, wherein said second module is operable to insert a guard interval into said received signal.

19. The apparatus of claim 17, wherein the apparatus is operable to apply orthogonal frequency division multiplexing to said first signal and to insert one or more virtual sub-carriers into said second signal.

20. The transmitter comprising:
a processing arrangement to process a high data rate signal, the processing arrangement including:
a plurality of data processing units;
a switching arrangement to receive a first signal at a high first data rate and to switch said first signal between inputs of said plurality of data processing units at regular time intervals,
wherein each of said plurality of data processing units is operable to process said first signal at a second data rate less than said high first data rate to form respective second signals; and
a combining arrangement to switch between outputs of said plurality of data processing units to form a processed high data rate signal from a combination of said respective second signals.

21. A receiver comprising:
a converting arrangement to convert a high data rate signal output by a transmitter following processing by said transmitter of a first high data rate signal, the converting arrangement being operable to cooperate with the transmitter and including:
a plurality of data processing units,
a demultiplexing arrangement to receive a high data rate signal output by said transmitter, and to demultiplex the received signal for input to said plurality of data processing units,
wherein each of said plurality of data processing units is operable to process said received high data rate signal to form signals which, when combined, correspond to said high first data rate signal;
wherein the transmitter includes a processing arrangement to process a high data rate signal, the processing arrangement including:
another plurality of data processing units,
a switching arrangement to receive a first signal at a high first data rate and to switch said first signal between inputs of said another plurality of data processing units at regular time intervals,
wherein each of said another plurality of data processing units is operable to process said first signal at a second data rate less than said high first data rate to form respective second signals, and
a combining arrangement to switch between outputs of said another plurality of data processing units to form a processed high data rate signal from a combination of said respective second signals.

22. A transceiver comprising:
a transmitter including:
a processing arrangement to process a high data rate signal, the processing arrangement including:
a plurality of data processing units,
a switching arrangement to receive a first signal at a high first data rate and to switch said first signal between inputs of said plurality of data processing units at regular time intervals,
wherein each of said plurality of data processing units is operable to process said first signal at a second data rate less than said high first data rate to form respective second signals, and
a combining arrangement to switch between outputs of said plurality of data processing units to form a processed high data rate signal from a combination of said respective second signals; and
a receiver including:
a converting arrangement to convert a high data rate signal output by said transmitter following processing by said transmitter of a first high data rate signal, the converting arrangement being operable to cooperate with the transmitter and including:
another plurality of data processing units, and
a demultiplexing arrangement to receive a high data rate signal output by said transmitter, and to demultiplex the received signal for input to said another plurality of data processing units,
wherein each of said another plurality of data processing units is operable to process said received high data rate signal to form signals which, when combined, correspond to said high first data rate signal.

23. A modem comprising:
an apparatus for processing a high data rate signal, including:
a plurality of data processing units, and
a switching arrangement to receive a first signal at a high first data rate and to switch said first signal between inputs of said plurality of data processing units at regular time intervals,
wherein each of said plurality of data processing units is operable to process said first signal at a second data rate less than said high first data rate to form respective second signals; and
a combining arrangement to switch between outputs of said plurality of data processing units to form a processed high data rate signal from a combination of said respective second signals.

24. A method for processing a high data rate signal, the method comprising:
receiving a first signal at high first data rate;
dividing said first signal into respective parts at regular time intervals;
processing respective parts of said first signal at a second data rate less than said high first data rate to form respective second signals; and
combining said respective second signals to form a processed high data rate signal.

25. The method of claim 24, further comprising:
processing a streaming first signal into blocks of data for forming said respective parts.

26. The method of claim 24, further comprising:
processing said respective parts at a third data rate greater than said second data rate for inserting data points into said second signal to form a third signal.

27. The method of claim 24, further comprising:
inserting a guard interval into said second signal.

28. The method of claim 24, further comprising:
inserting at least one virtual sub-carrier into said second signal, wherein the method is operable for orthogonal frequency division multiplexing.

29. The method of claim 25, further comprising:
processing said respective parts at a third data rate greater than said second data rate for inserting data points into said second signal to form a third signal.

30. The method of claim 25, further comprising:
inserting a guard interval into said second signal.

31. The method of claim 25, further comprising:
inserting at least one virtual sub-carrier into said second signal, wherein the method is operable for orthogonal frequency division multiplexing.

32. The method of claim 26, further comprising:
inserting a guard interval into said second signal.

33. The method of claim 26, further comprising:
inserting at least one virtual sub-carrier into said second signal, wherein the method is operable for orthogonal frequency division multiplexing.

34. The apparatus of claim 18, wherein the apparatus is operable to apply orthogonal frequency division multiplexing to said first signal and to insert one or more virtual sub-carriers into said second signal.
